(19) United States
(12) Patent Application Publication
(10) Pub. No.: US 2003/0093659 A1
(43) Pub. Date: May 15, 2003

(54) Method and system for directly starting a PDA operating system on a portable PC using hardware devices

(76) Inventors: Say-Ling Wen, Taipei (TW); Chuan-Cheng Chiu, Taipei (TW)

Correspondence Address: BIRCH STEWART KOLASCH & BIRCH, PO BOX 747, FALLS CHURCH, VA, 22040-0747, US

(21) Appl. No.: 09/987,631

(22) Filed: Nov. 15, 2001

(51) Int. Cl. G06F 15/177

(52) U.S. Cl. 713/1

(57) ABSTRACT

The specification discloses a method and system for directly starting a PDA OS on a portable PC using a hardware device. Through the design of a hardware PDA starting element (such as a hot key), refreshing the BIOS bootstrap, and a built-in PDA OS, the system can directly start the bootstrap of the PDA OS once the PDA starting element is detected to be enabled. Otherwise, the basic OS preloaded in the portable PC (such as the Windows OS) is started. By using the disclosed method users can avoid the complicated power on procedure and achieve the goal of directly starting a PDA OS by the hardware of the invention.

### BACKGROUND OF THE INVENTION

1. Field of the Invention

The invention relates to a technique for providing a PDA (Personal Digital Assistant) OS (Operating System) in portable PC's, and particularly notebook PC's or equivalent electronic devices. More specifically, the disclosed method and system can be used to quickly start a PDA OS (including the OS's of hand held PC's, pocket PC's or other equivalent small electronic devices) by directly using a hot key during the power on procedure of the portable PC, and to use the portable PC as a PDA.

2. Related Art

With the increase in computer popularity, people often need to use computers to solve problems either at work or at home. In general, two major methods of obtaining information are: (1) from books, newspapers, journals, CD-ROM's, etc; and (2) from the network. However, both of these methods have drawbacks. The information obtained using the first method will become outdated as time progresses. Rapid exchange of information greatly shortens the life cycle of information. Such information recorded in media like books cannot be easily updated. The information obtained using the second method, however, continuously changes along with the development of the world, also resulting in some troubles for users. One can see the problems in the following points:

1. Existing personal computer OS's (Operating Systems), such as Windows 98, Windows 2000, Windows XP, Linux, and so on, are complicated despite (or because of) their powerful functions and designs. Moreover, the user operation designs are not intuitive and simple enough. This situation scares people without any computer background because of the obstacles they meet while using these systems.

2. Users who do not understand the network structure do not know where to start their searches. In this case, a user often chooses to use a familiar OS or to install several different OS's on the computer hardware platform. This type of system is called a dual-OS or a multi-OS. However, this method cannot solve the above problems because a utility is needed to switch between the OS's.

3. PDA's are becoming more popular nowadays. They have properties complementary to the desktop Windows OS, e.g. smaller volume, faster power on, more compact functions, and more convenient to use. Therefore, a method for supporting multiple PDA systems on a notebook PC is an important subject currently being studied. The user is then able to enjoy the functions of different PDA systems on the same notebook PC.

### SUMMARY OF THE INVENTION

An object of the invention is to implement an OS that can quickly start a PDA OS (including the OS's of hand held PC's, pocket PC's or other equivalent small electronic devices, all of which will be generally referred as the PDA OS) using a hardware device such as a hot key. A further object of the invention is to provide a notebook PC that can be quickly started and used as a PDA.

The disclosed method has the design of a hot key installed on a notebook PC. By pre-loading a PDA booting procedure in the BIOS (Basic Input Output System) of the notebook PC, the system will skip complicated hardware diagnostic steps in the normal booting procedure of the notebook PC if the hot key is detected by the BIOS to be depressed after power is turned on. The PDA OS pre-loaded in a storage device (such as an HD) of the notebook PC is directly started, initiating PDA utilities and thus entering the PDA operating environment.

The disclosed system is mainly based upon a notebook PC. In addition to the basic OS (such as the Windows OS) pre-loaded in the notebook, a booting procedure for the basic OS, and a power on button for the OS pre-loaded in typical portable computers, the notebook PC of the invention further contains:

a hot key, which is used to directly start the PDA OS;

a PDA OS, which is stored in a storage device of the notebook PC;

a PDA booting procedure, which is pre-loaded into the BIOS of the notebook PC for starting the PDA OS and opening a PDA utilities screen; and

a hot key detecting procedure, which is pre-loaded into the BIOS of the notebook PC for detecting whether the PDA hot key is depressed and running the PDA booting procedure if the hot key is depressed.

### BRIEF DESCRIPTION OF THE DRAWINGS

The invention will become more fully understood from the detailed description given hereinbelow. However, the following description is for purposes of illustration only, and thus is not limitative of the invention, wherein:

FIG. 1 is a flowchart showing the steps to implement the invention;

FIG. 2 shows a hardware structure of the invention;

FIG. 3 shows a system structure of the invention;

FIG. 4 is a flowchart showing the steps to directly start a PDA OS and its utilities using a hot key; and

FIG. 5 is a flowchart showing the detailed steps to directly start a PDA OS and its utilities using a hot key in accordance with another embodiment.

### DETAILED DESCRIPTION OF THE INVENTION

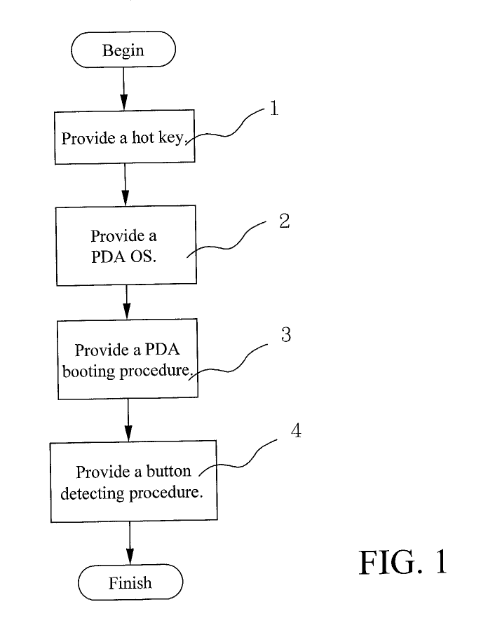

With reference to FIG. 1, the disclosed method includes the steps of:

1. providing a hot key, which is a hardware device installed on a notebook PC for its user to start a PDA system (the hot key can be a button or other hardware input device with analogous functions);

2. providing a PDA OS, which is pre-loaded into a storage device of the notebook PC, e.g. an HD, a CD-ROM, memory or other analogous recording media, to start a PDA operating environment and its utilities;

3. providing a PDA booting procedure, which is pre-loaded in a BIOS chip of the notebook PC for starting the PDA OS and opening a PDA utilities screen; and

4. providing a button detecting procedure, which is pre-loaded into the BIOS chip of the notebook PC and runs immediately after power is turned on for detecting whether the PDA hot key is depressed and running the corresponding PDA booting procedure if the hot key is depressed.

In addition, the notebook may include the step of installing a basic OS (such as the Windows OS) to start the basic OS and its utilities, so that the user can selectively start a PDA OS or the basic OS normally installed in the notebook. This step is to pre-load a basic OS, its booting procedure, and its utilities in the notebook. A power on button for starting the pre-loaded basic OS is further installed in the notebook PC. Therefore, users can selectively start the PDA OS or the basic OS by directly pressing the PDA hot key 20 or the power on button, respectively. The button detecting procedure detects which button is depressed. Once a depressed key is detected, the corresponding booting procedure is utilized to start the OS. For example, if the PDA hot key is detected to be depressed, the PDA booting procedure is utilized to start the PDA OS and its utilities. On the contrary, if the power on key is being depressed, then the basic OS normally pre-loaded in the portable computer is executed to start the basic OS and its utilities.

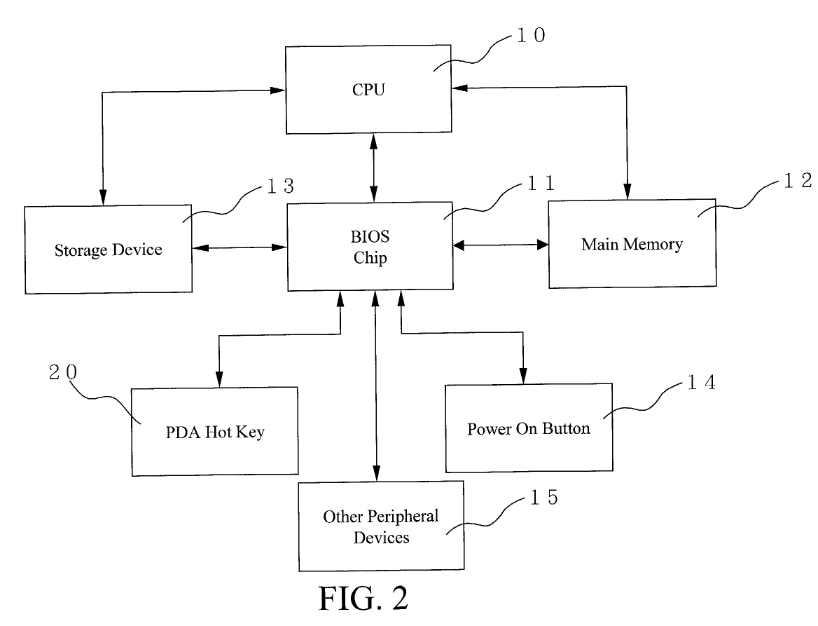

As shown in FIG. 2, the disclosed hardware structure is based upon the basic hardware devices in currently available notebook PC's, but adds an additional PDA hot key 20 for directly starting the PDA OS. The basic hardware devices of the notebook PC mentioned here include at least: a CPU (Central Processing Unit) 10, a BIOS chip 11, main memory 12, storage device 13 (such as an HD, a CD-ROM, memory or some other equivalent recording medium), a power on button 14, and other peripheral devices 15.

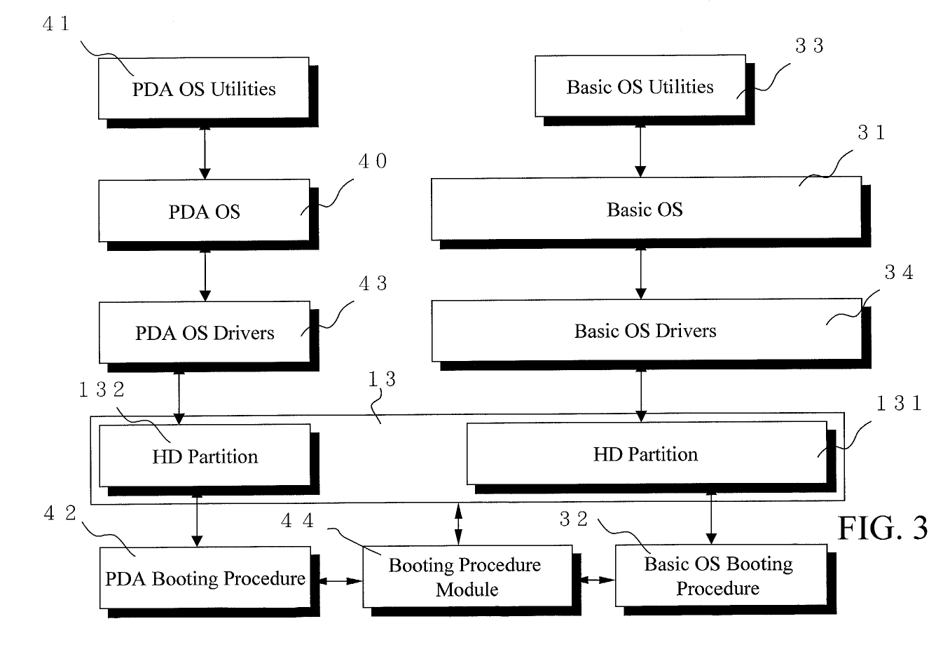

FIG. 3 shows the system structure of the invention. The system also includes a basic OS (e.g. Windows OS) 31 pre-loaded in the notebook PC, a basic OS booting procedure 32, and a utilities 33 for the basic OS 31, drivers 34 for the basic OS 31. In addition, the system further contains:

a PDA OS 40, which is stored in a storage device 13 (such as an HD) of the notebook PC;

utilities 41 for the PDA OS 40;

a PDA booting procedure 42, which is pre-loaded into a BIOS chip 11 of the notebook PC for starting the PDA OS 40 and PDA utilities 41;

drivers 43 of the PDA OS 40; and

a button detecting procedure 44, which is pre-loaded into the BIOS 11 of the notebook PC for detecting whether the PDA hot key 20 is depressed and running the corresponding PDA booting procedure 42 and the utilities 41 for the PDA OS 40 if the hot key 20 is depressed.

The software related to the basic OS 31 includes its utilities 33 and drivers 34. The software related to the PDA OS 41 includes its utilities 41 and drivers 43. The software is preferably stored in different partitions 131,132 of the HD of the notebook PC. The PDA booting procedure 42 and the basic OS booting procedure 32 are stored together in the BIOS chip 11 of the notebook PC.

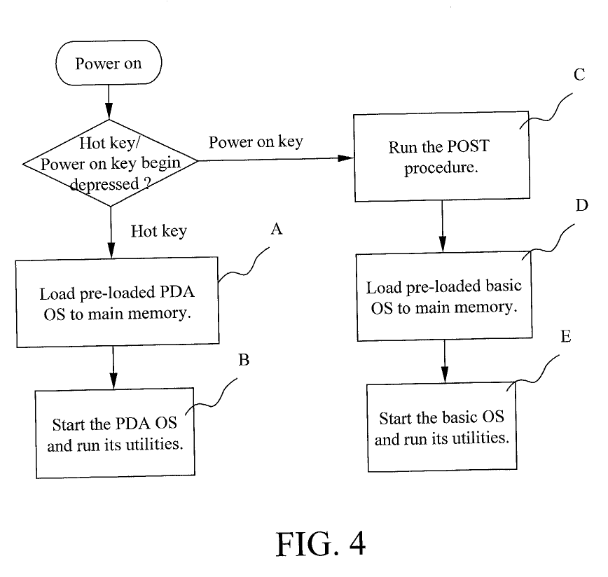

With reference to FIG. 4, the notebook PC using the disclosed techniques has the following operation procedures after the power is turned on:

A. When the button detecting procedure 44 detects that the hot key 20 is depressed, the pre-loaded PDA OS 40 is loaded to the main memory 12;

B. Start the PDA OS 40 and run its utilities 41;

C. When the button detecting procedure 44 detects that the power on button 14 is depressed, a POST (Power On Self Test) procedure is executed;

D. Load the basic OS 31 into the main memory 12; and

E. Start the basic OS 31 and run its utilities 33.

If the notebook PC is started with the basic OS 31 because of the power on button 14 is depressed, then complicated hardware diagnostic steps programmed in the booting procedure 32 are executed. This is the so-called POST. It mainly tests the size of the memory, the defects in the memory, the keyboard functions, the display interface card type, the types and models of the hard disk drive and floppy disk drive, and the functions of the interrupt controller and timer. If there is any conflict between the interface card settings and the host, a warning message will be displayed or the machine cannot be started. For printers, the tests include determining whether the print head is movable, if any paper is jammed inside, and whether the printer is connected to a computer. On the other hand, if the PDA OS 40 is started through the PDA booting procedure 42, the complicated hardware diagnostic steps will be skipped and the PDA system 40 pre-loaded into the storage device 13 (e.g. HD) of the notebook PC is directly started. The PDA utilities 41 are also loaded to quickly enter the PDA operating environment.

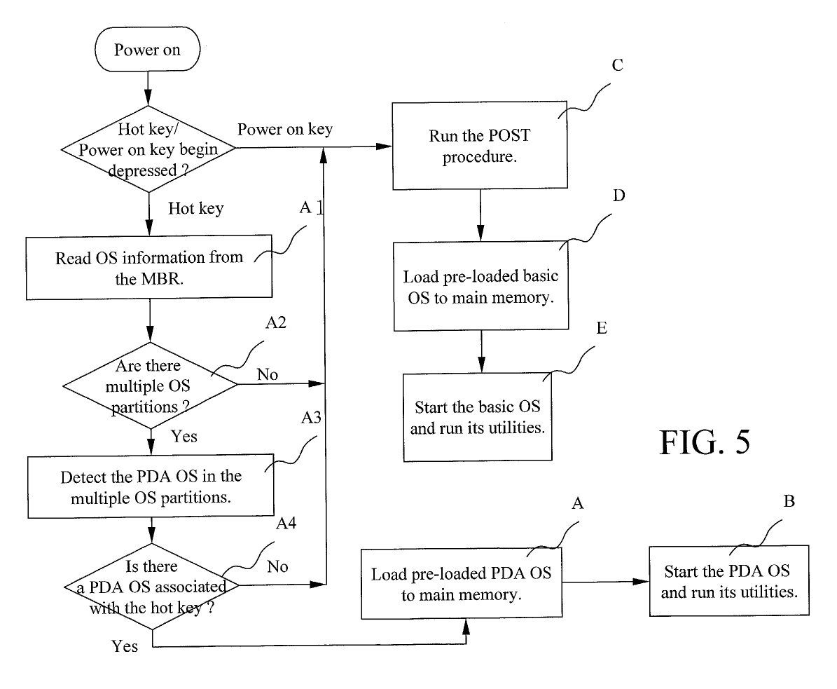

Finally, please refer to FIG. 5 for another embodiment of the invention based upon the steps demonstrated in FIG. 4. A few steps are inserted before step A in FIG. 4 to detect whether the PDA hot key 20 can correctly start the designated PDA OS 40. These steps can be implemented by refreshing the contents in the BIOS chip. These inserted steps are:

A1. Read information of the OS's pre-loaded into the notebook storage device 13 from an MBR (Main Boot Record);

A2. Determine whether there are multiple OS partitions. If there are, the next step follows; otherwise, continue directly to step C;

A3. Detect PDA OS's 40 in the multiple OS partitions; and

A4. Determine whether there is a PDA OS associated with the PDA hot key 20. If there is, step A follows to start the PDA OS 40 and to run the PDA utilities 41; otherwise, continue to step C to start the basic OS of the notebook PC and its utilities.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of using a hardware device to directly start a PDA OS in a portable computer, which comprises the steps of:
A. providing a PDA hot key for a user to depress to start the PDA system;
B. providing a PDA OS, which is pre-loaded into a storage device of the portable computer for providing a PDA operating environment in the portable computer;
C. providing a PDA booting procedure, which is pre-loaded into a BIOS chip of the portable computer for starting the PDA OS; and
D. providing a button detecting procedure, which is pre-loaded into the BIOS chip of the portable computer for running the PDA booting procedure when the PDA hot key is detected to be depressed.

2. The method of claim 1 further comprising the step of installing a basic OS in the portable computer starting the basic OS.

3. The method of claim 2, wherein the step of installing a basic OS in the portable computer starting the basic OS comprises the steps of: pre-loading a basic OS into the portable computer, a booting procedure for starting the basic OS, and its utilities and the portable computer has a power on button for starting the pre-loaded basic OS.

4. The method of claim 2 comprising the steps of:
A. loading the pre-loaded PDA OS to main memory when the PDA hot key is depressed;
B. starting the PDA OS and running its utilities;
C. running a POST (Power On Self Test) procedure when the power on button is depressed;
D. loading the basic OS into the main memory; and
E. starting the basic OS and running its utilities.

5. The method of claim 4, before the step of loading the pre-loaded PDA OS into the main memory, further comprising the steps of:
A1. reading information about the OS's already loaded into the storage device of the portable computer from an MBR (Master Boot Record);
A2. determining whether there are multiple OS partitions, and continuing to the next step when there are multiple OS partitions and to step C otherwise;
A3. detecting a PDA OS in the multiple OS partitions; and
A4. determining whether there is a PDA OS associated with the PDA hot key, and continuing to step A to start the PDA OS and to run its utilities if there is and to step C to start the basic OS and its utilities for the portable computer.

6. A system using a hardware device to directly start a PDA OS in a portable computer, comprising:
a PDA OS stored in a storage device of the portable computer;
utilities for the PDA OS;
a PDA hot key for directly starting the PDA OS;
a PDA booting procedure, which is pre-loaded into a BIOS chip of the portable
computer for starting the PDA OS and the PDA utilities;
drivers for the PDA OS; and
a button detecting procedure, which is pre-loaded into the BIOS chip of the portable computer for running the PDA booting procedure when the PDA hot key is detected to be depressed.

7. The system of claim 6 further comprising a basic OS (such as the Windows OS) pre-loaded into the portable computer, a booting procedure of the basic OS, utilities of the basic OS, drivers of the basic OS, and a power on button for starting the basic OS, wherein the basic OS is started after the power on button is detected to be depressed by the button detecting procedure.
